(19) United States
(12) Patent Application Publication
(10) Pub. No.: US 2026/0141599 A1
(43) Pub. Date: May 21, 2026

(54) IMAGE PROCESSING METHOD AND APPARATUS, DEVICE, STORAGE MEDIUM, AND PROGRAM PRODUCT

(71) Applicants: SENSETIME GROUP LIMITED, Hong Kong (CN); HONDA MOTOR CO., LTD., Tokyo (JP)

(72) Inventors: Takumi Iida, Hong Kong (CN); Hideki Matsunaga, Tokyo (JP)

(21) Appl. No.: 19/441,924

(22) Filed: Jan. 7, 2026

Related U.S. Application Data
(63) Continuation of application No. PCT/CN2024/104684, filed on Jul. 10, 2024.

(30) Foreign Application Priority Data
Jul. 14, 2023 (CN) 202310868168.3

(51) Int. Cl. G06T 11/60; G06T 5/50; G06V 10/25; G06V 10/77; G06V 20/70

(52) U.S. Cl. CPC G06T 11/60; G06T 5/50; G06V 10/25; G06V 10/7715; G06V 20/70; G06T 2207/20081; G06T 2207/20221

(57) ABSTRACT

An image processing method and apparatus, a device, a storage medium, and a program product are provided. The method includes: a placement region and a travelable region from an image to be pasted are acquired; an object image including an object to be pasted is placed into the placement region, and a composite image is generated; and label information representing whether the object to be pasted is a fallen object is generated based on a positional relationship between the travelable region and the placement region in the composite image.

### CROSS-REFERENCE TO RELATED APPLICATIONS

The present disclosure is a US continuation application of International Application No. PCT/CN2024/104684 filed on Jul. 10, 2024, which is proposed based on and claims the priority of the Chinese patent application with the application number of 202310868168.3 and the filing date of Jul. 14, 2023, entitled “Image Processing Method and Apparatus, Device, Storage Medium, and Program Product”. The disclosures of the above applications are hereby incorporated by reference in their entirety.

### BACKGROUND

In Advanced Driving Assistance System (ADAS) and automated driving, it is essential to avoid fallen objects or obstacles if the objects or obstacles are present on the road. However, learning fallen objects is difficult due to the small number and wide variety of fallen-object data samples available for collection. In related technologies, fallen object detection is achieved by training a fallen-object detection model based on a small amount of fallen-object data and generalizing the model.

### SUMMARY

The present disclosure relates to the technical field of computer vision, and in particular, to an image processing method and apparatus, a device, a storage medium, and a program product. Embodiments of the present disclosure provide at least an image processing method and apparatus, a device, a storage medium, and a program product.

The technical solutions in the embodiments of the present disclosure are implemented as follows.

In one aspect, an embodiment of the present disclosure provides an image processing method. The method includes: acquiring a placement region and a travelable region from an image to be pasted; placing, into the placement region, an object image comprising an object to be pasted, and generating a composite image; and generating, based on a positional relationship between the travelable region and the placement region in the composite image, label information representing whether the object to be pasted is a fallen object.

In another aspect, an embodiment of the present disclosure provides an image processing apparatus, including a first acquisition module, a first generation module and a second generation module.

The first acquisition module is configured to acquire a placement region and a travelable region from an image to be pasted.

The first generation module is configured to place, into the placement region, an object image comprising an object to be pasted, and generate a composite image.

The second generation module is configured to generate, based on a positional relationship between the travelable region and the placement region in the composite image, label information representing whether the object to be pasted is a fallen object.

In still another aspect, an embodiment of the present disclosure provides a computer device, comprising a memory and a processor. The memory stores a computer program executable on the processor. When executing the program, the processor implements some or all steps in the above method.

In yet another aspect, an embodiment of the present disclosure provides a computer-readable storage medium, having a computer program stored thereon. When executed by a processor, the computer program implements some or all steps in the above method.

In still yet another aspect, an embodiment of the present disclosure provides a computer program, comprising computer-readable code. When the computer-readable code is run in a computer device, a processor in the computer device performs execution to implement some or all steps in the above method.

In a further aspect, an embodiment of the present disclosure provides a computer program product, comprising a computer program or instructions. When executed by a processor, the computer program or the instructions implement some or all steps in the above method.

It should be understood that, the previous general description and the following detailed description are merely exemplary and illustrative, and do not limit the technical solutions of the present disclosure.

### BRIEF DESCRIPTION OF THE DRAWINGS

The accompanying drawings here are incorporated into the specification, constitute a part of the specification, illustrate embodiments compliant with the present disclosure, and are used together with the specification to describe the technical solutions of the present disclosure.

FIG. 1 is a schematic implementation flowchart of an image processing method according to an embodiment of the present disclosure;

FIG. 2 is another schematic implementation flowchart of an image processing method according to an embodiment of the present disclosure;

FIG. 3 is still another schematic implementation flowchart of an image processing method according to an embodiment of the present disclosure;

FIG. 4A is a schematic diagram of an application scenario of an image processing method according to an embodiment of the present disclosure;

FIG. 4B is a schematic diagram of another application scenario of an image processing method according to an embodiment of the present disclosure;

FIG. 5 is a schematic diagram of still another application scenario of an image processing method according to an embodiment of the present disclosure;

FIG. 6 is yet another schematic implementation flowchart of an image processing method according to an embodiment of the present disclosure;

FIG. 7 is a schematic diagram of an implementation framework of an image processing method according to an embodiment of the present disclosure;

FIG. 8 is a schematic diagram of the composition structure of an image processing apparatus according to an embodiment of the present disclosure; and

FIG. 9 is a schematic hardware entity diagram of a computer device according to an embodiment of the present disclosure.

### DETAILED DESCRIPTION

In related technologies, fallen object detection is achieved by training a fallen-object detection model based on a small amount of fallen-object data and generalizing the model. However, the performance of the trained fallen-object detection model tends to be relatively poor.

In the embodiments of the present disclosure, first, a placement region used to place an object to be pasted and a travelable region in an image to be pasted are acquired from the image to be pasted. Then, an object image comprising the object to be pasted is placed into the placement region to obtain a composite image. In this way, the placement region in the image to be pasted is replaced with the object image, so that a picture of the composite image comprises the object image and the travelable region. Finally, label information representing whether the object to be pasted is a fallen object is generated according to a positional relationship between the travelable region and the placement region. In this way, by analyzing the positional relationship between the travelable region and the placement region, a positional relationship between a position of the object image in the composite image and the travelable region can be determined, thereby learning whether the object to be pasted falls within the travelable region, so as to generate the label information representing whether the object to be pasted is a fallen object. As such, by generating the composite image carrying the label information, the composite image can be used as fallen-object sample data. In a process of generating the composite image, the label information can be generated by analyzing the positional relationship between the travelable region and the placement region. Hence, a large amount and a wide variety of fallen-object sample data can be obtained when generating the fallen-object sample data, without relying on the object to be pasted, and further sufficient fallen-object sample data can be provided for a training process of a fallen-object detection model.

To make the objectives, technical solutions, and advantages of the present disclosure clearer, the technical solutions of the present disclosure will be described in further detail below with reference to the accompanying drawings and embodiments. The described embodiments should not be regarded as limitations on the present disclosure. All other embodiments that are obtained by a person of ordinary skill in the art without inventive effort shall fall within the scope of protection of the present disclosure.

When the following description involves “some embodiments”, said phrasing describes a subset of all possible embodiments, but it can be understood that “some embodiments” may be the same subset or different subsets of all possible embodiments, and may be combined with each other when there is no conflict.

Unless otherwise defined, all technical and scientific terms used herein have the same meanings as commonly understood by a person of ordinary skill in the technical field to which the present disclosure belongs. The terms used herein are only for the purpose of describing the present disclosure, and are not intended to limit the present disclosure.

Before the embodiments of the present disclosure are further described in detail, the nouns and terms involved in the embodiments of the present disclosure are illustrated. The nouns and terms involved in the embodiments of the present disclosure are applicable to the following explanations.
1) Computer vision refers to machine vision, which uses video cameras and computers to replace human eyes to identify, track, and measure targets, and further performs graphic processing, so that images are processed by the computer to obtain images more suitable for observation by human eyes or detection by instruments.
2) Deep learning, which is intended to reduce the computation amount of a model, reduce the parameter number/volume of model, and reduce the inference time of the model.

An embodiment of the present disclosure provides an image processing method. The method can be executed by a processor of a computer device. The computer device may refer to a device with data processing capabilities, such as a server, a notebook computer, a tablet computer, a desktop computer, a smart television, or a mobile device (for example, a mobile phone, a portable video player, a personal digital assistant, a dedicated messaging device, or a portable gaming device). FIG. 1 is a schematic implementation flowchart of an image processing method according to an embodiment of the present disclosure. As shown in FIG. 1, the method includes the following steps S101 to S103.

Step S101: acquiring a placement region and a travelable region from an image to be pasted.

In some embodiments, the image to be pasted may be an image with complex picture content or an image with simple picture content. The obtained image to be pasted may be a two-dimensional image or a three-dimensional image. The image to be pasted may be an image including a traffic scene.

In some possible implementations, the image to be pasted is acquired by an image acquisition device performing image acquisition in a traffic scene, or may be a received image to be pasted of a traffic scene that is sent by another device, or may be an image randomly extracted from an image database, for example, an image acquired from a traffic road scene or an image acquired from a parking lot. The placement region in the image to be pasted may be any region in the image to be pasted. The placement region may be within the travelable region or outside the travelable region. Placement regions of different images to be pasted may be located in the same position or different positions in the images. The placement region in the image to be pasted may be presented as a binary image that has a black background, a white placement region, and an image size same as the size of the image to be pasted.

The travelable region in the image to be pasted indicates a region where vehicles can enter and exit, comprising: a road surface region on a road, a parking lot, a garage, or other regions where vehicles can enter and exit in the image to be pasted. The travelable region in the image to be pasted may be presented as a binary image that has a black background, a white travelable region, and an image size same as the size of the image to be pasted.

In a particular instance, the image to be pasted is an image acquired from a traffic road scene, and the travelable region is a region in which a road surface is located in the image. The placement region may be any region in the image and may be on the road surface or outside the road surface, for example, on a green belt on the road surface, or in midair, or on a roadside building, and so on.

Step S102: placing, into the placement region, an object image including an object to be pasted, and generating a composite image.

In some embodiments, the object to be pasted may be a two-dimensional object or a three-dimensional object. The object to be pasted may be an object of any type, which may be animal type, plant type, or other type, etc. The animal type may be a dog, a cat, or a goat, etc. The plant type may be a tree or a flower, etc. The other type may be any object that is relatively large in volume and may pose an obstacle to vehicles. The object image including an object to be pasted may be an image of the object itself, or may be an image including a background and the image to be pasted. The object image may be obtained by an image acquisition device performing image acquisition on the object to be pasted, or may be an image randomly selected from a database of images whose picture includes the object to be pasted, or may be a received object image that is sent by another device. The object image includes a two-dimensional object image or a three-dimensional object image. The image to be pasted includes a two-dimensional image to be pasted or a three-dimensional image to be pasted. In this way, the object image and the image to be pasted both include a two-dimensional image and a three-dimensional image, thereby enabling the composite image generated by the object image and the image to be pasted to have more diverse types.

In some possible implementations, the composite image is obtained by pasting the object image to the placement region to cover the placement region. In this way, the picture of the composite image includes the object image and the travelable region.

Step S103: generating, based on a positional relationship between the travelable region and the placement region, label information representing whether the object to be pasted is a fallen object.

In some embodiments, the positional relationship between the travelable region and the placement region is used to represent a belonging relationship between the travelable region and the placement region. The label information is used to indicate whether the object to be pasted is a fallen object, and includes: a fallen-object label and a non-fallen-object label. The label information may be represented by any form of identifier. For example, 0 is used to represent the non-fallen-object label and 1 is used to represent the fallen-object label, or Pinyin or letters may be used for representation, etc.

If the placement region belongs to the travelable region, it indicates that the placement region is within the range of the travelable region, thereby indicating that the object image is included within the range of the travelable region, and further indicating that the object to be pasted falls within the range of the travelable region, and will impact the traveling of vehicles. Based on this, it is determined that the object to be pasted is a fallen object, and label information representing that the object to be pasted is a fallen object is generated.

If the placement region does not belong to the travelable region, it indicates that the placement region is outside the range of the travelable region, thereby indicating that the object image is also outside the range of the travelable region, and further indicating that the object to be pasted does not fall within the range of the travelable region, and will not impact the traveling of vehicles. Based on this, it is determined that the object to be pasted is not a fallen object, and label information representing that the object to be pasted is not a fallen object is generated. In this way, by annotating the label information in the composite image, a wide variety of sample images with a fallen object or a non-fallen object annotated can be obtained.

In the embodiments of the present disclosure, the placement region in the image to be pasted is replaced with the object image, so that the picture of the composite image includes the object image and the travelable region. By analyzing the positional relationship between the travelable region and the placement region, a positional relationship between the position of the object image in the composite image and the travelable region can be determined. As such, the label information can be generated by analyzing the positional relationship between the travelable region and the placement region. In this way, a large amount and a wide variety of fallen-object sample data can be obtained when generating the fallen-object sample data without relying on the object to be pasted, so that sufficient fallen-object sample data can be further provided for training of a fallen-object detection model to improve the accuracy of the fallen-object detection model.

In some embodiments, acquiring the composite image by covering the placement region with the object image, i.e., the above step S102, may be implemented by means of the following process: covering the placement region with the object image to obtain the composite image.

In some possible implementations, the object image is pasted to the placement region to obtain the composite image. The area of the placement region is greater than or equal to the area of the object image, so that the object image is pasted to the placement region to cover a partial region in the placement region. Alternatively, a region having the same area as the object image in the placement region is replaced with the object image, thereby obtaining the composite image. As such, by covering at least a partial region of the placement region with the object image, the object to be pasted and the travelable region can be fully presented in the resultant composite image, thereby facilitating analysis of whether the object to be pasted falls in the travelable region.

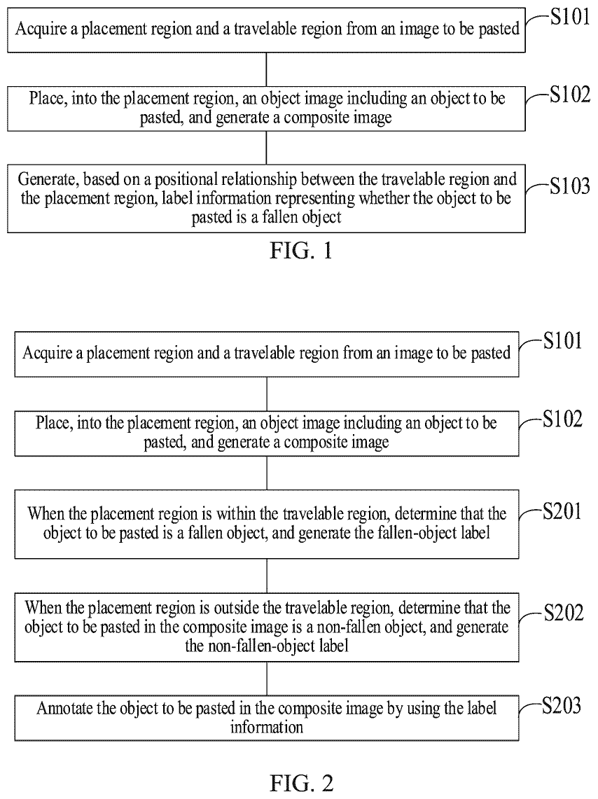

In some embodiments, the label information includes a fallen-object label and a non-fallen-object label. If the placement region is within the range of the travelable region, the generated label information is a fallen-object label, and the fallen-object label is used for annotation. If the placement region is not within the range of the travelable region, the generated label information is a non-fallen-object label, and the non-fallen-object label is used for annotation. That is, the above step S103 may be implemented by the steps shown in FIG. 2.

Step S201: in a case that the placement region is within the travelable region, determining that the object to be pasted is a fallen object, and generating the fallen-object label.

In some embodiments, if the placement region is within the travelable region, it indicates that the object image is pasted within the travelable region, thereby indicating that the object to be pasted falls within the travelable region and will impact the traveling of vehicles, and further indicating that the object to be pasted is a fallen object that affects traffic. Based on this, the fallen-object label representing that the object to be pasted is a fallen object is generated. For example, the placement region is located on a road surface in the travelable region. That is, the object to be pasted falls on the road surface, and the object to be pasted is a fallen object on the road surface. Therefore, a fallen-object label is generated for the object to be pasted. In the process of determining whether the object to be pasted is a fallen object, since fallen-object learning is carried out through actually placed objects to be pasted, the characteristics of the object have been taken into account during the placing process to implement the fallen-object learning. Since detection is performed by taking into account the characteristics of fallen objects, regions with uncertain segmentation and recognition will not be determined as fallen objects.

Step S202: in a case that the placement region is outside the travelable region, determining that the object to be pasted in the composite image is a non-fallen object, and generating the non-fallen-object label.

In some embodiments, if the placement region is outside the travelable region, it indicates that the object image is pasted outside the travelable region, thereby indicating that the object to be pasted falls outside the travelable region and will not impact the traveling of vehicles, and further indicating that the object to be pasted is not a fallen object. Based on this, the non-fallen-object label representing that the object to be pasted is not a fallen object is generated.

Step S203: annotating the object to be pasted in the composite image by using the label information.

In some embodiments, after determining whether the object to be pasted is a fallen object, the object to be pasted is annotated by using the generated label information, thereby resulting in an annotated composite image including the label information. In this way, the annotated composite image serves as fallen-object sample data annotated with the label information. If the object to be pasted is a fallen object, the object to be pasted is annotated by using the fallen-object label. By annotating the object to be pasted with the fallen-object label, fallen-object positive sample data annotated with the fallen-object label can be obtained. If the object to be pasted is a non-fallen object, the object to be pasted is annotated by using the non-fallen-object label. By annotating the object to be pasted with the non-fallen-object label, fallen-object negative sample data annotated with the non-fallen-object label can be obtained.

In the embodiments of the present disclosure, if the object to be pasted is within the travelable region, the fallen-object label representing that the object to be pasted is a fallen object is generated. Then, by annotating the object to be pasted as a fallen object in the composite image by using the fallen-object label, a composite image that can serve as fallen-object positive sample data can be obtained. If the object to be pasted is outside the travelable region, the non-fallen-object label representing that the object to be pasted is not a fallen object is generated. Then, by annotating the object to be pasted as not a fallen object in the composite image by using the non-fallen-object label, a composite image that can serve as fallen-object negative sample data can be obtained. In this way, a large amount and a wide variety of fallen-object sample data can be obtained through the annotated fallen-object positive sample data and fallen-object negative sample data. In addition, whether the object to be pasted is a fallen object is determined by determining whether the object to be pasted falls within the travelable region, so that whether the object to be pasted is a fallen object is independent of the characteristics of the object itself, thereby enabling the resultant fallen-object sample data to be relatively stable.

In some possible implementations, the object to be pasted can be annotated using the following various methods.

Method 1: using the label information to perform segmented annotation on the object to be pasted in the composite image.

In some embodiments, each segment of the segmented object to be pasted is annotated through the segmented annotation. In the composite image, the object to be pasted can be divided into a plurality of segments according to a coverage relationship between the position of the object to be pasted and the travelable region to obtain the segmented object to be pasted, and each segment of the segmented object to be pasted is annotated by using the label information. For example, one part of the object to be pasted is within the travelable region and the other part is outside the travelable region. In this case, the object to be pasted can be divided into two segments, with one segment annotated as a fallen object and one segment annotated as a non-fallen object.

Method 2: annotating, with a bounding box, the object to be pasted in the composite image by using the label information.

In some embodiments, the bounding box may be a rectangular box capable of enclosing the object to be pasted. By means of the rectangular box, the object to be pasted is annotated according to the label information, so as to obtain the object to be pasted in which the label information is annotated by the rectangular box, thereby obtaining an annotated composite image that can serve as fallen-object sample data.

Method 3: annotating the object image in the composite image by using the label information.

In some embodiments, in the placement region in the composite image, the entire object image is annotated by using the label information to obtain an object image annotated with the label information, thereby obtaining an annotated composite image that can serve as fallen-object sample data. In this way, by annotating the object to be pasted as a fallen object or a non-fallen object using any one or more of the above methods, the object to be pasted can be accurately and quickly annotated as a positive sample or a negative sample, thereby facilitating classification of fallen-object sample data.

In some embodiments, the object image including the object to be pasted may be implemented using the following various methods.

Method 1: selecting the object image including the object to be pasted from an object image library.

In some embodiments, the object image library includes any type of images of the object to be pasted. The images in the object image library may be two-dimensional images or three-dimensional images. An arbitrary image is selected as the object image from the object image library. In this way, fallen-object sample data obtained from the object image has more diverse types.

Method 2: generating the object image based on the object to be pasted.

In some embodiments, the object image is obtained by performing image acquisition on the object to be pasted, or by scanning the object to be pasted, or by drawing the object to be pasted, etc.

In the above methods 1 and 2, by selecting the object image from the object image library or by generating the object image, it is possible to obtain the object image that includes any type of object to be pasted, enabling the object image to have diverse types. In this way, a wide variety of fallen-object sample data can be obtained according to the diverse types of the object image.

In some embodiments, the travelable region in the image to be pasted can be obtained using the following various methods.

Method 1: determining, based on input indication information, the travelable region from the image to be pasted.

In some embodiments, the indication information is used to indicate the position of the travelable region in the image to be pasted. The indication information may be input autonomously by a user, that is, the user selects, by a means, the travelable region from the image to be pasted. For example, the user manually draws the travelable region on the image to be pasted, so as to circle the travelable region. Alternatively, the user inputs the indication information through a button, so as to draw the travelable region according to the position of the travelable region in the indication information.

Method 2: based on picture content of the image to be pasted, performing region estimation on the image to be pasted, and determining the travelable region.

In some embodiments, the picture content of the image to be pasted includes various types of objects in the background and foreground of the image to be pasted. By recognizing various types of objects in the foreground, a region where vehicles can enter and exit is obtained. For example, a road, a garage, a parking lot, and other regions where vehicles can enter and exit in the foreground may be delineated to obtain the travelable region.

Method 3: determining the travelable region based on annotated information in the image to be pasted.

In some embodiments, the annotated information in the image to be pasted can represent the types of objects contained in each region of the object to be pasted. For example, if the picture of the image to be pasted includes a building, a road, and greening plants, the annotated information includes a building label, a road label, and a greening plant label. In this way, which region is the travelable region can be learned from the annotated information, and the travelable region can be precisely delineated from the image to be pasted.

In the above methods 1 to 3, the travelable region may be determined by manual or automatic selection, and the travelable region may also be determined by region estimation, so that the coverage range of the travelable region acquired from the image to be pasted can be wider and more precise.

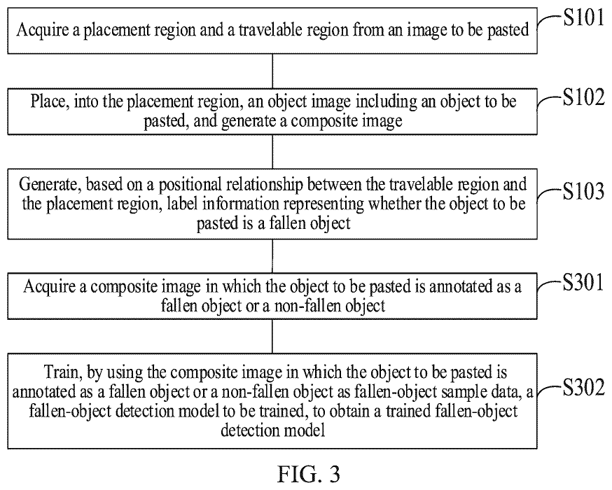

In some embodiments, after generating the composite image in which the object to be pasted is annotated as a fallen object or a non-fallen object using the label information, that is, after step S103, a fallen-object detection model is trained by using the annotated composite image as fallen-object sample data, so as to obtain a trained fallen-object detection module, which may be implemented by the steps shown in FIG. 3.

Step S301: acquiring a composite image in which the object to be pasted is annotated as a fallen object or a non-fallen object.

In some embodiments, since whether the object to be pasted is a fallen object is related to whether the object falls within the travelable region, even in the case of the same object, the corresponding label information may vary with a different placement position. For example, the object to be pasted is a puppy, the image of the puppy is placed within a travelable region in a first image to be pasted, and the image of the puppy is placed outside the travelable region in a second image to be pasted. In this case, in two resultant composite images, the label of the puppy in the first composite image is a fallen-object label, and the label of the puppy in the second composite image is a non-fallen-object label. As such, whether the object to be pasted is a fallen object is determined through the position of the object image in the image to be pasted, without relying on the generated attributes of a fallen object. Such a practice enables the resultant annotated composite image to have relatively high stability.

Step S302: training, by using the composite image in which the object to be pasted is annotated as a fallen object or a non-fallen object as fallen-object sample data, a fallen-object detection model to be trained, to obtain a trained fallen-object detection model.

In some embodiments, the annotated composite image is used as the fallen-object sample data, thereby providing a large amount of sample data with a relatively wide variety of fallen objects for the fallen-object detection model to be trained. In this way, using the fallen-object sample data to train the fallen-object detection model enables the trained fallen-object detection model to have higher generalization performance.

In some embodiments, by dividing the fallen-object sample data into positive samples and negative samples, the fallen-object detection model is trained using comparative learning techniques. That is, the above step S302 may be implemented by the following steps S321 to S323 (not shown).

Step S321: performing feature extraction on a plurality of frames of fallen-object sample data to obtain an image feature set.

In some embodiments, a feature extractor is used to perform feature extraction on the plurality of frames of fallen-object sample data to obtain an image feature of each frame of fallen-object sample data, thereby obtaining the image feature set. The image feature of each frame of fallen-object sample data carries label information representing whether the sample data is a fallen object.

Step S322: based on label information of the plurality of frames of fallen-object sample data, using image features annotated with a fallen-object label in the image feature set as positive samples, and using image features annotated with a non-fallen-object label in the image feature set as negative samples.

In some embodiments, according to the label information, it can be learned whether the object to be pasted in the fallen-object sample data is a fallen object. In the image feature set of the fallen-object sample data, according to the annotated label information, the image features with the fallen-object label are classified as positive samples, and the image features with the non-fallen-object label are classified as negative samples, so that the image feature set is divided into two types of samples, i.e., the positive samples and the negative samples, thereby facilitating comparative learning by the fallen-object detection model.

Step S323: training, based on the image features of the positive samples and the image features of the negative samples, the fallen-object detection model to be trained, to obtain the trained fallen-object detection model.

In some embodiments, by using the image features of the positive samples and the image features of the negative samples, the fallen-object detection model to be trained is provided with sample data with clear boundaries. In this way, network parameters of the fallen-object detection model can be adjusted based on the image features of the positive samples and the image features of the negative samples, thereby achieving a trained fallen-object detection model with relatively high detection accuracy.

In the embodiments of the present disclosure, by dividing the image feature set of the fallen-object sample data into the positive samples and the negative samples, comparative learning can be performed through the positive samples and the negative samples during training of the fallen-object detection model, making the boundary between a fallen object and a non-fallen object clearer. Thus, the trained fallen-object detection model can achieve a more accurate detection result.

In some embodiments, a distance between image features having the same label is decreased, and a distance between image features having different labels is increased, so that the boundary between a positive sample and a negative sample is clearer. That is, the above step S323 can be implemented by the following steps.

Step 1: among the image features of the positive samples and the image features of the negative samples, decreasing a distance between image features having the same label information, and increasing a distance between image features having different label information, to obtain adjusted image features of the positive samples and adjusted image features of the negative samples.

In some embodiments, among the image features of the positive samples and the image features of the negative samples, a distance between image features belonging to the positive samples and a distance between image features belonging to the negative samples are respectively decreased, whereas a distance between image features of the positive samples and image features of the negative samples are increased, thereby resulting in the adjusted image features of the positive samples and the adjusted image features of the negative samples.

Step 2: adjusting, based on the adjusted image features of the positive samples and the adjusted image features of the negative samples, network parameters of the fallen-object detection model to be trained, to obtain the trained fallen-object detection model.

In some embodiments, by using the adjusted image features of the positive samples and the adjusted image features of the negative samples that are obtained after the adjustment of the distances between the image features, the network parameters of the fallen-object detection model to be trained are adjusted, so as to implement the training process of the fallen-object detection model to be trained, thereby obtaining the trained fallen-object detection model. In this way, the distance between the features having the same label is decreased so that the distance between the features having the same label is shorter, and the distance between the features having different labels is increased so that the distance between the features having different labels is greater. Hence, the fallen-object detection model to be trained can more accurately learn about objects to be pasted that have different labels, so that the trained fallen-object detection model can more accurately classify the objects to be pasted that have different labels.

The following describes an application of the image processing method provided in the embodiments of the present disclosure in an actual scenario by using the generation of fallen object samples in autonomous driving as an example.

In the related art, a fallen-object detection model is trained using a small amount of fallen-object data, and the fallen-object detection model is generalized to detect fallen objects. However, generalization is difficult for fallen objects that cannot be defined as unique objects, and it is difficult to learn about fallen objects with a small amount of data. In addition, a segmentation model tends to erroneously detect a fallen-object region. As a result, using a region estimated based on a segmentation failure to finally detect a fallen object leads to relatively low accuracy. However, it is sometimes necessary to cooperate with a segmentation model without considering the similarity between fallen objects, and such simple estimation results in low reliability of region segmentation.

In the embodiments of the present disclosure, fallen-object data is generated to solve the problem of the insufficiency of fallen-object data. In addition, by learning about generated fallen objects, it is possible to perform fallen object detection with object similarities between fallen objects taken into consideration.

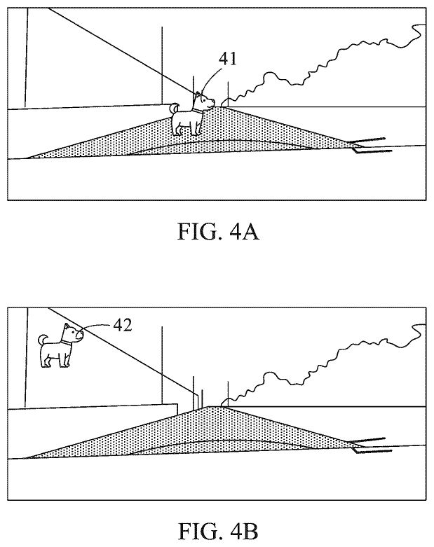

In some embodiments, for fallen-object learning, if an object is placed on a road surface, this object is a fallen object. If an object is placed outside the road surface, this object is not a fallen object. As shown in FIG. 4A, a puppy 41 is on a road surface in FIG. 4A, and it is determined that the puppy 41 is a fallen object. In FIG. 4B, a puppy 42 is not on a road surface, and it is determined that the puppy 42 is not a fallen object. The fallen-object detection model is trained by generating learning data of an object whose fallen status is to be learned, so as to obtain a trained model.

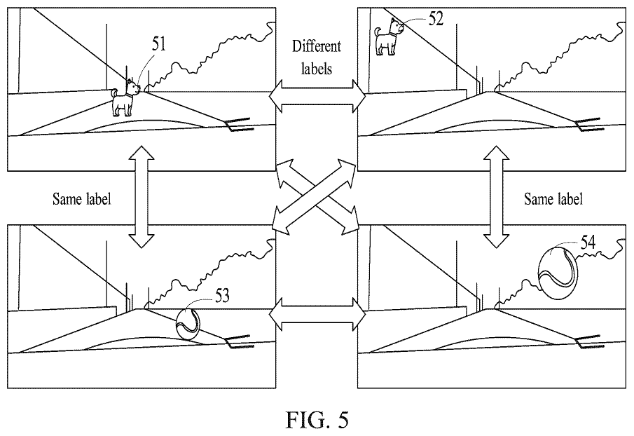

In some possible implementations, on a premise that a fallen object serving as an object under detection is located on a road surface, an object being placed on the road surface is learned as a fallen object, while an object being placed outside the road surface is learned as a non-fallen object. Even if the object placed on the road surface and the object placed outside the road surface are the same object, it is determined that the object placed outside the road surface is not a fallen object, thereby preventing the object itself from being learned as a fallen object. The features of fallen objects are drawn closer regardless of the types of objects. On the contrary, even in the case of the same object, the features are separated from each other if not a fallen object. For example, a fallen object and a non-fallen object can be separated by increasing a distance between a positive sample and a negative sample. As shown in FIG. 5, a puppy 51 is on a road surface and it is determined that the puppy is a fallen object. A puppy 52 is outside a road surface and it is determined that the puppy is not a fallen object. A sphere 53 is on a road surface and it is determined that the sphere is a fallen object. A sphere 54 is outside a road surface and it is determined that the sphere is not a fallen object. Although the puppy 51 and the puppy 52 are the same object, label information thereof are different, where one is a fallen object and the other is a non-fallen object. Therefore, features corresponding to the puppy 51 and the puppy 52 are separated from each other. The sphere 53 and the sphere 54 are the same object, but one is a fallen object and the other is a non-fallen object. Therefore, features corresponding to the sphere 53 and the sphere 54 are separated from each other. The features corresponding to the puppy 51 and the sphere 53 are drawn closer, while the features of the puppy 52 and the sphere 54 are drawn closer. In the embodiments of the present disclosure, since fallen objects themselves can be directly learned, there is no need to cooperate with a segmentation model. Moreover, since an object being actually placed on a road surface is learned as a fallen object, detection can be performed by taking the characteristics of the object into consideration.

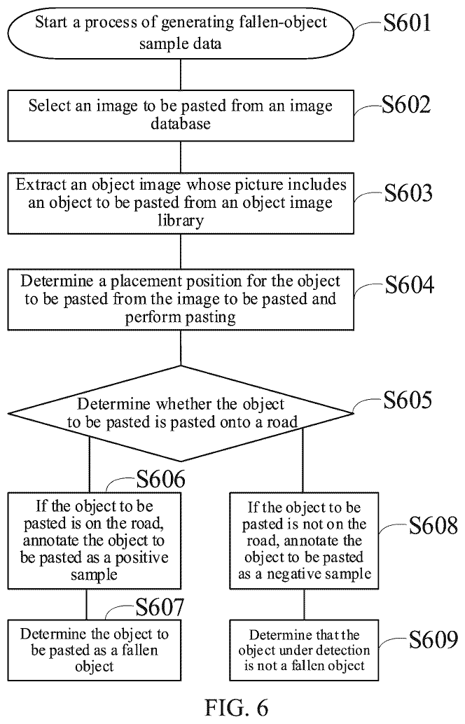

FIG. 6 is yet another schematic implementation flowchart of an image processing method according to an embodiment of the present disclosure. The following description is provided with reference to the steps shown in FIG. 6.

Step S601: starting a process of generating fallen-object sample data.

Step S602: selecting an image to be pasted from an image database.

In some possible implementations, the image database contains background images to be pasted, for example, a travel data image set such as CityScapes or BDD100K.

Step S603: extracting an object image including an object to be pasted from an object image library.

In some possible implementations, the object database contains a variety of objects to be pasted, for example, an image set of detection object data such as COCO or VOC, etc. The object to be pasted is learned as a “fallen object” candidate. Whether the object to be pasted is a fallen object or not is determined depending on the position at which the object is pasted.

Step S604: determining a placement position for the object to be pasted from the image to be pasted and performing pasting.

Step S605: determining whether the object to be pasted is pasted onto a road.

In some possible implementations, if the object to be pasted is on the road, step S606 is performed. If the object to be pasted is not on the road, step S608 is performed.

Step S606: if the object to be pasted is on the road, annotating the object to be pasted as a positive sample.

In some possible implementations, if the object to be pasted is pasted onto the road, it can be determined that a fallen object falls on the road, so the object to be pasted is annotated as a positive sample.

Step S607: determining the object to be pasted as a fallen object.

Step S608: if the object to be pasted is not on the road, annotating the object to be pasted as a negative sample.

In some possible implementations, if the object to be pasted is pasted to a position outside the road, such as the sky, then it is determined that the object to be pasted cannot possibly be a fallen object, and the object to be pasted is annotated as a negative sample.

Step S609: determining that the object under detection is not a fallen object.

In the embodiments of the present disclosure, data of fallen objects is not required in model learning. Even in the case of the same object for which a fallen-object label and a non-fallen-object label are changed through a placement position, fallen-object detection can be performed according to a certain position of the object, without relying on the attributes of fallen objects generated during learning.

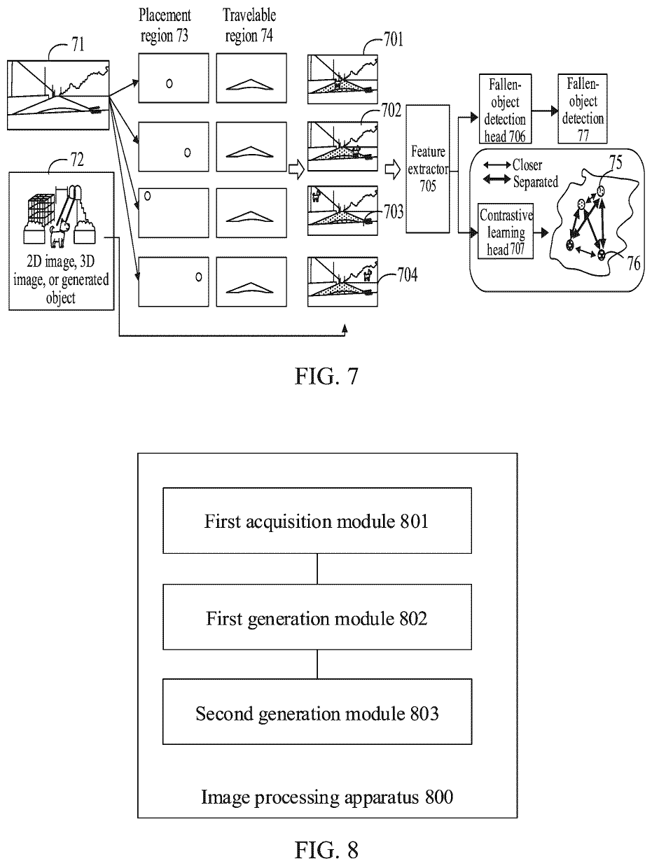

In some possible implementations, the above steps S601 to S609 can be implemented through a framework diagram shown in FIG. 7. FIG. 7 is a schematic diagram of an implementation framework of an image processing method according to an embodiment of the present disclosure. In FIG. 7, an image 71 is an image to be pasted, an object 72 is an object to be pasted, and the object 72 may be a 2D image, a 3D image, or a generated object. Four different placement regions are set in the image 71, as shown by four placement regions 73 separately corresponding to the image 71. Travelable regions 74 are extracted from the image 71. The object 72 is respectively placed in the four placement regions, resulting in composite images 701, 702, 703, and 704. The object to be pasted in the composite images 701 and 702 is located in the travelable region 74 to serve as positive samples. The object to be pasted in the composite images 703 and 704 is located outside the travelable region 74 to serve as negative samples. Then, a feature extractor 705 is used to perform feature extraction on the composite images 701, 702, 703, and 704. A fallen-object detection head 706 is used to perform fallen-object detection 77 on extracted features, so as to detect whether a fallen object is present in the extracted features. A contrastive learning head 707 is used to classify vectors of the extracted features, so as to classify the feature vectors as fallen-object vectors 75 and non-fallen-object vectors 76. A distance between vectors of the same type (for example, both being fallen objects or both being non-fallen objects) is decreased, whereas a distance between vectors of different types (for example, a fallen object and a non-fallen object) is increased.

In the embodiments of the present disclosure, there is no need to actually collect fallen-object sample data. Even in the case of the same object, generated label information varies with a different placement region. By performing analysis based on positions of the travelable region and the placement region in the image, fallen-object detection can be performed without relying on the attributes of fallen objects themselves. In addition, since such a practice is independent of a segmentation-based fallen-object learning and detection model, the practice is not affected by the segmentation model. A user can create a fallen-object detection model without fallen-object data. Since fallen objects can be stably detected without relying on specific objects, the trained fallen-object detection model can perform fallen-object detection with higher accuracy.

Based on the foregoing embodiments, an embodiment of the present disclosure provides an image processing apparatus. Units and modules included in the units included in the apparatus may be implemented by a processor in a computer device, and certainly may also be implemented by specific logic circuits. In the implementation process, the processor may be a central processing unit (CPU), a microprocessor unit (MPU), a digital signal processor (DSP), or a field programmable gate array (FPGA), etc.

FIG. 8 is a schematic diagram of the composition structure of an image processing apparatus according to an embodiment of the present disclosure. As shown in FIG. 8, the image processing apparatus 800 includes: a first acquisition module 801, a first generation module 802 and a second generation module 803.

The first acquisition module 801 is configured to acquire a placement region and a travelable region from an image to be pasted.

The first generation module 802 is configured to place, into the placement region, an object image including an object to be pasted, and generate a composite image.

The second generation module 803 is configured to generate, based on a positional relationship between the travelable region and the placement region in the composite image, label information representing whether the object to be pasted is a fallen object.

In some embodiments, the first generation module 802 is further configured to: cover the placement region with the object image to obtain the composite image.

In some embodiments, the label information includes the fallen-object label and the non-fallen-object label. The second generation module 803 includes: a first determining sub-module and a second determining sub-module.

The first determining sub-module is configured to: in a case that the placement region is within the travelable region, determine that the object to be pasted in the composite image is a fallen object, and generate the fallen-object label.

The second determining sub-module is configured to: in a case that the placement region is outside the travelable region, determine that the object to be pasted in the composite image is a non-fallen object, and generate the non-fallen-object label.

In some embodiments, the apparatus further includes a first annotation module, configured to annotate the object to be pasted in the composite image by using the label information.

In some embodiments, the first annotation module includes any one of: a first annotation sub-module, a second annotation sub-module and a third annotation sub-module.

The first annotation sub-module is configured to perform segmented annotation on the object to be pasted in the composite image by using the label information, where each segment of the segmented object to be pasted is annotated through the segmented annotation.

The second annotation sub-module is configured to annotate, with a bounding box, the object to be pasted in the composite image by using the label information.

The third annotation sub-module is configured to annotate the object image in the composite image by using the label information.

In some embodiments, the apparatus further includes a first selection module and a third generation module.

The first selection module is configured to select the object image including the object to be pasted from an object image library.

The third generation module is configured to generate the object image based on the object to be pasted.

In some embodiments, the first acquisition module 801 includes any one of: a third determining sub-module, a first estimation sub-module and a fourth determining sub-module.

The third determining sub-module is configured to determine, based on input indication information, the travelable region from the image to be pasted, wherein the indication information is used to indicate a position of the travelable region in the image to be pasted;

The first estimation sub-module is configured to perform, based on picture content of the image to be pasted, region estimation on the image to be pasted, and determine the travelable region.

The fourth determining sub-module is configured to determine the travelable region based on annotated information in the image to be pasted.

In some embodiments, the object image includes: a two-dimensional object image or a three-dimensional object image. The image to be pasted includes: a two-dimensional image to be pasted or a three-dimensional image to be pasted.

In some embodiments, the apparatus further includes a second acquisition module and a first training module.

The second acquisition module is configured to acquire a composite image in which the object to be pasted is annotated as a fallen object or a non-fallen object.

The first training module is configured to: train, by using the composite image in which the object to be pasted is annotated as a fallen object or a non-fallen object as fallen-object sample data, a fallen-object detection model to be trained, to obtain a trained fallen-object detection model.

In some embodiments, the first training module includes a first extraction sub-module, a first division sub-module, and a first training sub-module.

The first extraction sub-module is configured to perform feature extraction on a plurality of frames of fallen-object sample data to obtain an image feature set.

The first division sub-module is configured to: based on label information of the plurality of frames of fallen-object sample data, use image features annotated with a fallen-object label in the image feature set as positive samples, and use image features annotated with a non-fallen-object label in the image feature set as negative samples.

The first training sub-module is configured to train, based on the image features of the positive samples and the image features of the negative samples, the fallen-object detection model to be trained, to obtain the trained fallen-object detection model.

In some embodiments, the first training sub-module includes a first adjustment unit and a second adjustment unit.

The first adjustment unit is configured to: among the image features of the positive samples and the image features of the negative samples, decrease a distance between image features having the same label information, and increase a distance between image features having different label information, to obtain adjusted image features of the positive samples and adjusted image features of the negative samples.

The second adjustment unit is configured to adjust, based on the adjusted image features of the positive samples and the adjusted image features of the negative samples, network parameters of the fallen-object detection model to be trained, to obtain the trained fallen-object detection model.

The above description of the apparatus embodiments is similar to the description of the method embodiments described above, and has similar beneficial effects as the method embodiments. In some embodiments, the functions of the apparatus or the modules included therein according to the embodiments of the present disclosure may be used to perform the method described in the above method embodiments. For technical details not disclosed in the apparatus embodiments of the present disclosure, reference may be made to the description of the method embodiments of the present disclosure for understanding.

It should be noted that, in the embodiments of the present disclosure, if the above-mentioned image processing method is implemented in the form of software functional modules and sold or used as separate products, the software functional modules may also be stored in a computer-readable storage medium. On the basis of such an understanding, the technical solutions of the embodiments of the present disclosure in essence, or the part of the technical solutions of the embodiments of the present disclosure that contributes to the related technologies, may be embodied in the form of a software product, and the software product is stored in a storage medium, including several instructions used for making a computer device (which may be a personal computer, a server, or a network device, etc.) perform all or part of the method described in the various embodiments of the present disclosure. The foregoing storage medium includes: a USB flash disk, a mobile hard disk, a read-only memory (ROM), a magnetic disk, an optical disc, or other media that can store program code. In this way, the embodiments of the present disclosure are not limited to any specific hardware, software, or firmware, or any combination of hardware, software, or firmware.

An embodiment of the present disclosure provides a computer device, including a memory and a processor. The memory stores a computer program executable on the processor. When executing the program, the processor implements some or all of the steps of the above method.

An embodiment of the present disclosure provides a computer-readable storage medium, having a computer program stored thereon. When executed by a processor, the computer program implements some or all of the steps of the above method. The computer-readable storage medium may be transitory or non-transitory.

An embodiment of the present disclosure provides a computer program, including computer-readable code. When the computer-readable code is run in a computer device, a processor in the computer device performs execution to implement some or all of the steps of the above method.

An embodiment of the present disclosure provides a computer program product. The computer program product includes a non-transitory computer-readable storage medium storing a computer program. When the computer program is read and executed by a computer, some or all of the steps of the above method are implemented. The computer program product may be specifically implemented by hardware, software, or a combination thereof. In some embodiments, the computer program product is embodied as a computer storage medium, and in other embodiments, the computer program product is embodied as a software product, such as a Software Development Kit (SDK), etc.

It should be pointed out here that: the above description of the various embodiments tends to emphasize the differences between the various embodiments. For the same or similar parts of the embodiments, reference may be made to the embodiments mutually. The above description of the device, storage medium, computer program, and computer program product embodiments is similar to the description of the method embodiments described above, and has similar beneficial effects as the method embodiments. For technical details not disclosed in the device, storage medium, computer program, and computer program product embodiments of the present disclosure, reference may be made to the description of the method embodiments of the present disclosure for understanding.

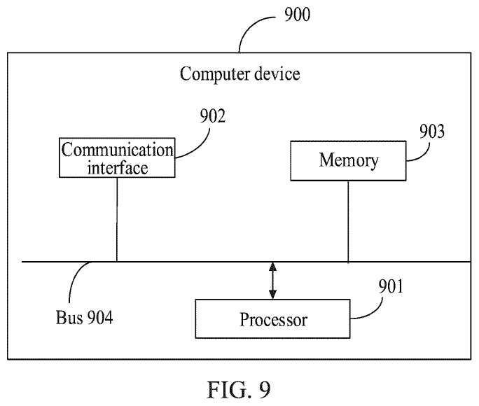

It should be noted that, FIG. 9 is a schematic hardware entity diagram of a computer device according to an embodiment of the present disclosure. As shown in FIG. 9, the hardware entities of the computer device 900 include: a processor 901, a communication interface 902, and a memory 903.

The processor 901 usually controls overall operations of the computer device 900.

The communication interface 902 can enable the computer device to communicate with other terminals or servers over a network.

The memory 903 is configured to store instructions and applications executable by the processor 901, and may also cache data (for example, image data, audio data, voice communication data, and video communication data) to be processed or already processed by the processor 901 and various modules in the computer device 900. The memory may be implemented by a flash memory (FLASH) or a Random Access Memory (RAM). Data may be transferred between the processor 901, the communication interface 902, and the memory 903 through a bus 904.

It should be understood that “one embodiment” or “an embodiment” mentioned throughout the specification means that a particular feature, structure, or characteristic related to the embodiment is included in at least one embodiment of the present disclosure. Therefore, “in one embodiment” or “in an embodiment” appearing throughout the specification does not necessarily refer to the same embodiment. Furthermore, the particular feature, structure, or characteristic may be incorporated in one or more embodiments in any suitable embodiment. It should be understood that, in various embodiments of the present disclosure, the size of the sequence numbers of various steps/processes described above does not imply the order of execution, and the order of execution of various steps/processes should be determined by functions and internal logic thereof, and should not constitute any limitation on the implementation process of the embodiments of the present disclosure. The above-mentioned sequence numbers of the embodiments of the present disclosure are merely for the purpose of description and do not represent advantages or disadvantages of the embodiments.

It should be noted that the terms “comprising”, “including”, or any other variation thereof herein are intended to indicate non-exclusive inclusion, so that processes, methods, objects, or apparatuses including a series of elements not only include those elements, but also include other elements not explicitly listed, or further include elements inherent to such processes, methods, objects, or apparatuses. In the absence of more limitations, an element defined by the statement “comprising a . . . ” does not preclude the presence of additional same elements in a process, method, object or device that includes the element.

In several embodiments provided by the present disclosure, it should be understood that the disclosed devices and methods may be implemented in other embodiments. The device embodiment described above is only illustrative. For example, the division of the units is merely a logical function division. In actual implementation, there may be another division embodiment, for example: a plurality of units or components may be combined or integrated into another system, or some features may be ignored or not executed. In addition, the displayed or discussed coupling or direct coupling or communication connections between various constituent parts may be by means of some interfaces, and the indirect coupling or communication connections of devices or units may be in electrical, mechanical, or other forms.

The units described as separate parts may or may not be physically separated, and the parts displayed as units may or may not be physical units. That is, the parts may be located in one place, or may be distributed to a plurality of network units. Some or all of the units may be selected according to actual needs to achieve the objective of the solution of the present embodiment.

In addition, the functional units in various embodiments of the present disclosure may all be integrated in one processing unit, or each unit may separately and individually function as one unit, or two or more units may be integrated into one unit. The integrated units described above may be implemented in the form of hardware or in the form of hardware plus software functional units.

A person of ordinary skill in the art can understand that: all or some steps in the above method embodiments may be completed by means of hardware related to program instructions. The program mentioned above may be stored in a computer-readable storage medium. When executed, the program executes and includes the steps in the above method embodiments. The foregoing storage medium includes: a mobile storage device, a read-only memory (ROM), a magnetic disk, an optical disc, or other media that can store program code.

Alternatively, if the integrated units described above of the present disclosure are implemented in the form of software functional modules and sold or used as separate products, the software functional modules may be stored in a computer-readable storage medium. On the basis of such an understanding, the technical solutions of the present disclosure in essence, or the part of the technical solutions of the present disclosure that contributes to the related technologies, may be embodied in the form of a software product, and the computer software product is stored in a storage medium, including several instructions used for making a computer device (which may be a personal computer, a server, or a network device, etc.) perform all or part of the methods described in the various embodiments of the present disclosure. The foregoing storage medium includes: a mobile storage device, a ROM, a magnetic disk, an optical disc, or other media that can store program code.

The above is merely a description of the embodiments of the present disclosure, but the protection scope of the present disclosure is not limited thereto. Any person skilled in the art can easily conceive of changes or substitutions within the technical scope disclosed in the present disclosure, and all of the changes or substitutions should be covered by the protection scope of the present disclosure.

What is claimed is:

1. An image processing method, comprising:
acquiring a placement region and a travelable region from an image to be pasted;
placing, into the placement region, an object image comprising an object to be pasted, and generating a composite image; and
generating, based on a positional relationship between the travelable region and the placement region in the composite image, label information representing whether the object to be pasted is a fallen object.

2. The method according to claim 1, wherein the label information comprises a fallen-object label and a non-fallen-object label; and the generating, based on a positional relationship between the travelable region and the placement region in the composite image, label information representing whether the object to be pasted is a fallen object comprises:
in a case that the placement region is within the travelable region, determining that the object to be pasted in the composite image is a fallen object, and generating the fallen-object label;
in a case that the placement region is outside the travelable region, determining that the object to be pasted in the composite image is a non-fallen object, and generating the non-fallen-object label.

3. The method according to claim 1, wherein after the generating, based on a positional relationship between the travelable region and the placement region, label information representing whether the object to be pasted is a fallen object, the method further comprises:
annotating the object to be pasted in the composite image by using the label information.

4. The method according to claim 3, wherein the annotating the object to be pasted in the composite image by using the label information comprises any one of the following:
performing segmented annotation on the object to be pasted in the composite image by using the label information, wherein each segment of the segmented object to be pasted is annotated with the segmented annotation;
annotating, with a bounding box, the object to be pasted in the composite image by using the label information; and
annotating the object image in the composite image by using the label information.

5. The method according to claim 1, wherein the object image is obtained in the following way:
selecting the object image comprising the object to be pasted from an object image library;
or, generating the object image based on the object to be pasted.

6. The method according to claim 1, wherein the acquiring a travelable region from an image to be pasted comprises any one of the following:
determining, based on input indication information, the travelable region from the image to be pasted, wherein the indication information is used to indicate a position of the travelable region in the image to be pasted;
based on picture content of the image to be pasted, performing region estimation on the image to be pasted, and determining the travelable region; and
determining the travelable region based on annotated information in the image to be pasted.

7. The method according to claim 1, wherein after the generating, based on a positional relationship between the travelable region and the placement region, label information representing whether the object to be pasted is a fallen object, the method further comprises:
acquiring a composite image in which the object to be pasted is annotated as a fallen object or a non-fallen object; and
training, by using the composite image in which the object to be pasted is annotated as a fallen object or a non-fallen object as fallen-object sample data, a fallen-object detection model to be trained, to obtain a trained fallen-object detection model.

8. The method according to claim 7, wherein the training, by using the composite image in which the object to be pasted is annotated as a fallen object or a non-fallen object as fallen-object sample data, a fallen-object detection model to be trained, to obtain a trained fallen-object detection model comprises:
performing feature extraction on a plurality of frames of fallen-object sample data to obtain an image feature set;
based on label information of the plurality of frames of fallen-object sample data, using image features annotated with a fallen-object label in the image feature set as positive samples, and using image features annotated with a non-fallen-object label in the image feature set as negative samples; and
training, based on the image features of the positive samples and the image features of the negative samples, the fallen-object detection model to be trained, to obtain the trained fallen-object detection model.

9. The method according to claim 8, wherein the training, based on the image features of the positive samples and the image features of the negative samples, the fallen-object detection model to be trained, to obtain the trained fallen-object detection model comprises:
among the image features of the positive samples and the image features of the negative samples, decreasing a distance between image features having the same label information and increasing a distance between image features having different label information, to obtain adjusted image features of the positive samples and adjusted image features of the negative samples; and
adjusting, based on the adjusted image features of the positive samples and the adjusted image features of the negative samples, network parameters of the fallen-object detection model to be trained, to obtain the trained fallen-object detection model.

10. A computer device, comprising a memory and a processor, wherein the memory stores a computer program executable on the processor, and when executing the program, the processor performs operations comprising:
placing, into the placement region, an object image comprising an object to be pasted, and generating a composite image; and
generating, based on a positional relationship between the travelable region and the placement region in the composite image, label information representing whether the object to be pasted is a fallen object.

11. The computer device according to claim 10, wherein the label information comprises a fallen-object label and a non-fallen-object label; and when executing the program, the processor further performs operations comprises:
in a case that the placement region is within the travelable region, determining that the object to be pasted in the composite image is a fallen object, and generating the fallen-object label;
in a case that the placement region is outside the travelable region, determining that the object to be pasted in the composite image is a non-fallen object, and generating the non-fallen-object label.

12. The computer device according to claim 10, wherein when executing the program, the processor further performs operations comprises:
annotating the object to be pasted in the composite image by using the label information.

13. The computer device according to claim 12, wherein when executing the program, the processor further performs operations comprises:
performing segmented annotation on the object to be pasted in the composite image by using the label information, wherein each segment of the segmented object to be pasted is annotated through the segmented annotation;
annotating, with a bounding box, the object to be pasted in the composite image by using the label information; and
annotating the object image in the composite image by using the label information.

14. The computer device according to claim 10, wherein when executing the program, the processor further performs operations comprises:
selecting the object image comprising the object to be pasted from an object image library;
or, generating the object image based on the object to be pasted.

15. The computer device according to claim 10, wherein when executing the program, the processor further performs operations comprises:
determining, based on input indication information, the travelable region from the image to be pasted, wherein the indication information is used to indicate a position of the travelable region in the image to be pasted;
based on picture content of the image to be pasted, performing region estimation on the image to be pasted, and determining the travelable region; and
determining the travelable region based on annotated information in the image to be pasted.

16. The computer device according to claim 10, wherein when executing the program, the processor further performs operations comprises:
acquiring a composite image in which the object to be pasted is annotated as a fallen object or a non-fallen object; and
training, by using the composite image in which the object to be pasted is annotated as a fallen object or a non-fallen object as fallen-object sample data, a fallen-object detection model to be trained, to obtain a trained fallen-object detection model.

17. The computer device according to claim 16, wherein when executing the program, the processor further performs operations comprises:
performing feature extraction on a plurality of frames of fallen-object sample data to obtain an image feature set;
based on label information of the plurality of frames of fallen-object sample data, using image features annotated with a fallen-object label in the image feature set as positive samples, and using image features annotated with a non-fallen-object label in the image feature set as negative samples; and
training, based on the image features of the positive samples and the image features of the negative samples, the fallen-object detection model to be trained, to obtain the trained fallen-object detection model.

18. The computer device according to claim 17, wherein when executing the program, the processor further performs operations comprises:
among the image features of the positive samples and the image features of the negative samples, decreasing a distance between image features having the same label information and increasing a distance between image features having different label information, to obtain adjusted image features of the positive samples and adjusted image features of the negative samples; and
adjusting, based on the adjusted image features of the positive samples and the adjusted image features of the negative samples, network parameters of the fallen-object detection model to be trained, to obtain the trained fallen-object detection model.

19. A non-transitory computer-readable storage medium, having a computer program stored thereon, wherein when the computer program is executed by a processor, the processor is caused to implement operations comprising:
acquiring a placement region and a travelable region from an image to be pasted;
placing, into the placement region, an object image comprising an object to be pasted, and generating a composite image; and
generating, based on a positional relationship between the travelable region and the placement region in the composite image, label information representing whether the object to be pasted is a fallen object.

20. The non-transitory computer-readable storage medium according to claim 19, wherein the label information comprises a fallen-object label and a non-fallen-object label; and when the computer program is executed by the processor, the processor is further caused to implement operations comprising:
in a case that the placement region is within the travelable region, determining that the object to be pasted in the composite image is a fallen object, and generating the fallen-object label;
in a case that the placement region is outside the travelable region, determining that the object to be pasted in the composite image is a non-fallen object, and generating the non-fallen-object label.
